(19) United States
(12) Patent Application Publication
(10) Pub. No.: US 2003/0149669 A1
(43) Pub. Date: Aug. 7, 2003

(54) Method and system for licensing intellectual property circuits

(76) Inventors: Michael C. Howells, San Jose, CA (US); Jean-Francois Cote, Chelsea (CA)

Correspondence Address: LOGICVISION (CANADA), INC., 1525 CARLING AVENUE, SUITE 404, OTTAWA, ON, K1Z 8R9, CA

(21) Appl. No.: 10/357,203

(22) Filed: Feb. 4, 2003

Related U.S. Application Data
(60) Provisional application No. 60/353,962, filed on Feb. 5, 2002.

(51) Int. Cl. G06F 17/60

(52) U.S. Cl. 705/51

(57) ABSTRACT

A method of controlling access to Intellectual Property (IP) -blocks embedded in a circuit comprises decoding a circuit usage rights file associated with the circuit and delineating usage rights associated with the IP blocks, determining from the circuit usage rights file whether access to an IP block to be accessed is permitted; and accessing the IP block only if access is permitted.

### CROSS-REFERENCE TO RELATED APPLICATIONS

This application claims the benefit of Provisional Application Serial No. 60/353,962 filed Feb. 5, 2002.

### BACKGROUND OF THE INVENTION

1. Field of the invention

The present invention relates in general to a method and system for restricting access to circuits and, more specifically, to a method and system for distributing intellectual property (IP) in the form of IP circuit blocks which are embedded within a licensee's integrated circuit.

As circuits continue to become smaller and more complex and the need to reduce time to market increases, it is becoming more common to license IP circuits or blocks from specialized providers. IP blocks may consist of a complete core which is embedded in a circuit or a specialized circuit which is embedded in a core. In design for testability (DFT), IP blocks are typically in the form of test controller circuitry. A variety of test controller circuits are available from LogicVision, Inc., the assignee of the present invention. Some test controllers have a number of optional features or modes of operation which are available for an additional license fee. In addition, the test controllers may be licensed for use in the design and simulation only or, for additional license fees, rights may also be acquired for use in manufacturing, board testing and/or system testing. Thus, a core provider may only be interested in design rights and may not wish to incur the additional expense of licensing rights, which the core provider will not use. However, a chip developer may license a core from a core provider (and other core providers) and may wish to acquire the rights to use one or more of the test controllers to test chips during manufacturing. Similarly, a circuit board manufacturer may wish to license the right to use the test controllers for performing testing of the circuit boards during manufacture of the boards, but may not wish to incur the expense of purchasing rights for use of the test controllers in performing system testing. Similar comments apply to a system developer. It will be seen then that different licensees will use the controllers for different purposes.

From the perspective of an IP block vendor, who may license the IP blocks to many core providers and system integrators, the IP block vendor wishes to provide a simple and effective method of restricting access to the IP blocks so that only authorized licensees of the IP blocks will have access to them, while also permitting access rights to be upgraded or renewed from time to time.

Typically, accessing specialized functions of an integrated circuit, such as test controller diagnostic functions, for example, is performed by accessing files which are contained in an integrated circuit library and electronic design automation (EDA) tools provided by an IP circuit block vendor. The circuit library is created by specialized software tools that create the IP blocks. As part of licensing arrangement with respective customers, the libraries may be transferred from a core provider to a system integrator, from a circuit integrator to a circuit manufacturer who, in turn, may pass the library on to a board and system developers.

2. Description of Related Art

Various methods have been developed for restricting access to IP circuit blocks.

Redman et al. U.S. Pat. No. 5,979,476 granted on Nov. 2, 1999 for “Access Restriction to Circuit Designs” discloses a method for restricting access to certain information respecting a circuit design to a user while permitting some processing of the information by a computerized system for the user. The patent proposes encrypting a circuit design file which is used to generate a desired output product and providing design processing software for use in generating the output circuit product. An authorization code provided by the vendor indicates the permissions which have been licensed to the user. The permissions may include identification of a class of encrypted design files, including the encrypted design file, to which the permissions apply, the identification made up of a vendor identification (ID) code and a product ID code, identification of a set of applicable users, including the user, to which the permissions apply, the identification made up of a “dongle number” (in some implementations, the set of applicable users simply defaults to “all users”), the classes of output products which the applicable users have permission to receive, i.e., the access privileges, and, for each of the classes of access-permitted output products, any expiration date on the applicable users' permissions to receive those output products. The computerized system includes a permission verification system which accepts an authorization code that indicates permissions for the user with regard to the encrypted design file. When the authorization code is verified, the design processing software generates the desired output product. Authorization information is embedded in the file header of the encrypted design file. The information placed in the file header also includes key information that provides information related to a decryption key, which is to be used by the design processing system to decrypt the encrypted design file. When the licensed rights expire, rights may be upgraded by providing a replacement encrypted design file with updated rights.

Garst et al. U.S. Pat. No. 6,188,995 granted on Feb. 13, 2001 for “Method and. Apparatus for Enforcing Software Licenses” discloses a method and apparatus for enforcing software licenses for resource libraries such as an application program interface (API), a toolkit, a framework, a runtime library, a dynamic link library (DLL), an applet (e.g. a Java or ActiveX applet), or any other reusable resource. The invention allows the resource library to be selectively used only by authorized end user software programs. The patent proposes embedding a license text string and a corresponding license key in a program that has been licensed to use a resource library. The license text string and the license key are supplied, for example, by a resource library vendor to a program developer who wants to use the resource library with an end user program being developed. The license text string includes information about the terms of the license under which the end user program is allowed to use the resource library. The license key is used to authenticate the license text string. The resource library in turn is provided with means for reading the license text string and the license key, and for determining, using the license key, whether the license text string is authentic and whether the license text string has been altered. Resource library functions are made available only to a program having an authentic and unaltered license text string.

Garst et al. is not concerned with the licensing of IP blocks intended to be embedded in cores of core providers or in circuits of circuit developers, which may, in turn, be licensed or sold to other parties.

### SUMMARY OF THE INVENTION

The present invention seeks to provide a method of controlling access to and licensing IP blocks which are embedded within a licensees' circuit and which permits rights to be updated or upgraded from time to time, even if a licensee was not an original licensee of the IP blocks.

One aspect of the present invention is generally defined as a method of controlling access to Intellectual Property (IP) blocks embedded in a circuit, comprising decoding an encrypted IP block usage rights file associated with said circuit and which delineates usage rights associated with said IP block; determining from said usage rights file whether access to said IP block is permitted; and accessing said IP block only if access thereto is permitted.

Another aspect of the present invention is generally defined as a system for licensing IP blocks embedded in circuits, comprising an IP block generator for generating an IP block, creating an IP block information file, inserting in the IP block information file, IP block access information and usage rights information associated with the IP block, and encrypting the IP block information file; a circuit database generator for creating a database of predetermined files associated with each IP block embedded in the circuit and of any other blocks embedded in the circuit and for creating a circuit usage rights file and encrypting the circuit usage right file for the circuit; and an application program for accessing the IP blocks, the access program being operable to decrypt a circuit usage rights file associated with the circuit, verify that rights to access the IP block have not expired, determine whether required IP block rights have been licensed for use and access the IP block if required rights have been licensed and have not expired.

### BRIEF DESCRIPTION OF THE DRAWINGS

These and other features of the invention will become more apparent from the following description in which reference is made to the appended drawings in which:

FIG. 1 is a diagrammatic view of a circuit having embedded IP blocks with a number of the IP blocks residing in an embedded core;

FIG. 2 is a view which illustrates the manner in which IP block usage rights may be acquired by different parties from IP block vendors;

FIG. 3 is a diagrammatic view of a system, according to an embodiment of the present invention, for creating and assembling IP blocks in a circuit in a manner which will restrict access to the IP blocks to unauthorized users;

FIG. 4 is a view illustrating the content of a circuit usage rights file according to an embodiment of the present invention; and

FIG. 5 is a view illustrating the content of an Master usage rights file according to an embodiment of the present invention.

### DETAILED DESCRIPTION OF EMBODIMENTS OF THE INVENTION

In the following detailed description, numerous specific details are set forth in order to provide a thorough understanding of the present invention, However, it will be understood by those skilled in the art that the present invention may be practiced without these specific details. In other instances, well known methods, procedures, components and circuits have not been described in detail so as not to obscure aspects of the present invention.

In the following description, an Intellectual Property (IP) block refers to any licensed circuit, circuit block or circuit sub-block.

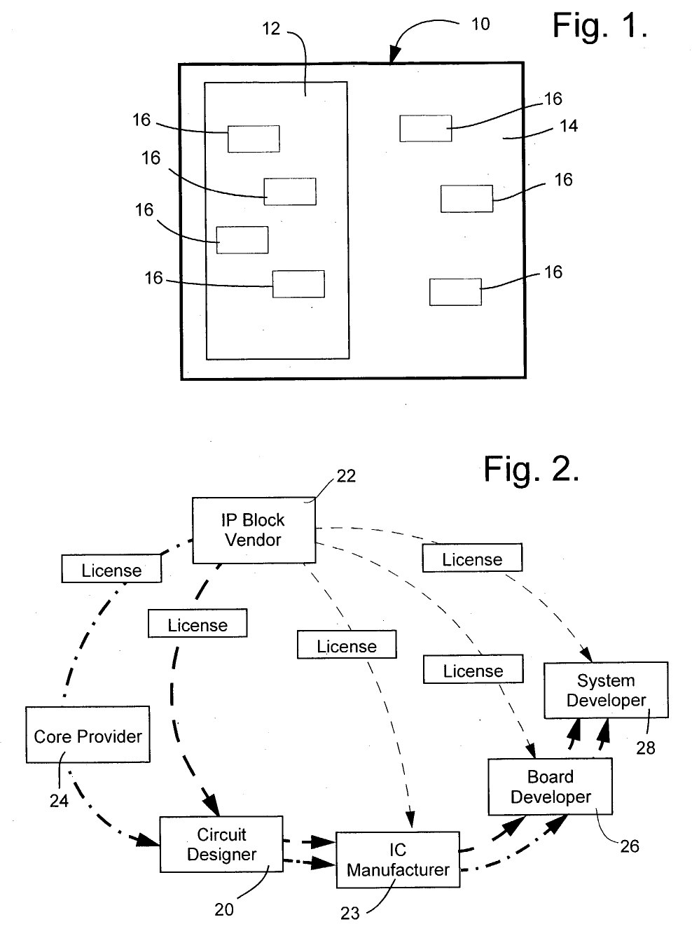

FIG. 1 diagrammatically illustrates a circuit 10 having a core or block 12. Core 12 and a top module 14 are shown with a number of embedded IP blocks 16 which have been licensed from an IP block vendor. The present invention provides a method and a system for restricting access to the IP blocks in accordance with restrictions in a license. IP blocks may originate from several sources as illustrated in FIG. 2. A circuit designer 20 secures a license from an IP block vendor 22 to generate and use IP blocks in a circuit under development. These IP blocks are embedded in top module 14. Core 12 was acquired from a core provider 24 who secured a license respecting the embedded IP blocks from an IP block vendor and who embedded corresponding IP blocks in core 12. The rights acquired from the IP block vendor by the circuit designer are different from those of the core provider. For example, the respective rights will have different expiration dates and cover different combinations of IP block features. The usage rights granted to the circuit designer may have included rights to use the IP blocks for testing of the circuit during manufacture. A circuit manufacturer 23 could use the IP blocks if the circuit designer acquired such rights. Otherwise, the circuit manufacturer could acquire new rights if the level of usage rights which were transferred with the circuit are insufficient for the features required by the circuit manufacturer. Similarly, a board developer 26 may desire rights to use the IP blocks for testing during the development of a circuit board incorporating the circuit designed by designer 20 and manufactured by manufacturer 23. Again, these usage rights could have been acquired by the circuit designer and transferred to the circuit board developer in a manner described later. If the rights were not included, they may be acquired directly from the IP vendor as shown in dotted lines in FIG. 2. The same applies to system developer 28. In the present invention, the circuit designer may send a handoff database containing an IP block information file and usage rights file directly to the board and/or system designer.

It will be understood that a circuit may incorporate IP blocks which originate from several different IP block vendors. The method of the present invention is able to distinguish between usage rights granted by a single IP block vendor to different licensees as well as usage rights granted by multiple IP block vendors to one or more different licensees and allows any of these various rights to be upgraded and/or updated.

In accordance with the present invention, the right to access or use IP blocks are delineated in an encrypted circuit IP block usage rights file associated with the circuit in which the IP blocks are embedded. In general, the present invention provides a method of controlling access to Intellectual Property (IP) blocks embedded in a circuit, by decoding a circuit usage rights file associated with the circuit and delineating usage rights associated with the IP block, determining from the circuit usage rights file whether access to the IP block is permitted; and accessing the IP block only if access thereto is permitted.

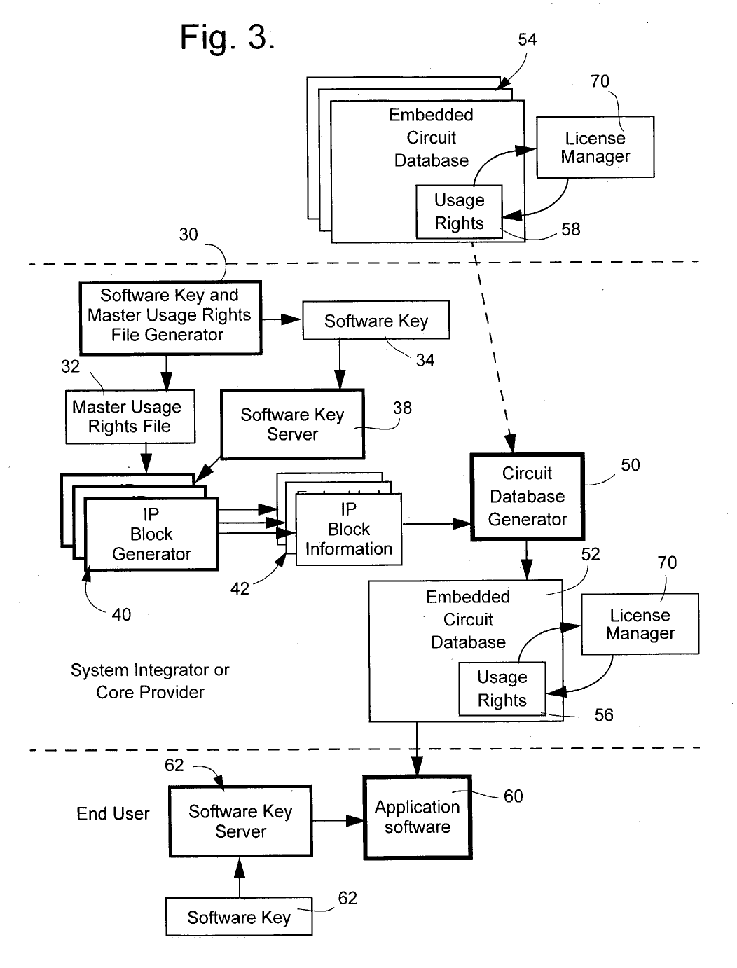

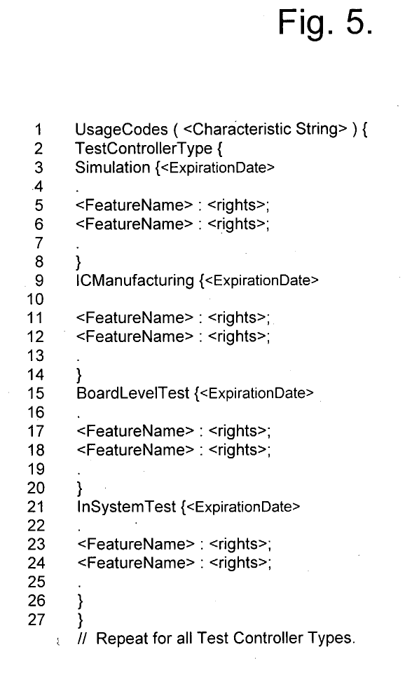

A system 25 for implementing the method of the present invention is generally illustrated in FIG. 3. The system includes a key generation program or module 30 that generates a master usage rights file 32. Master usage rights file 32, illustrated in FIG. 5 and described in more detail later, contains usage rights for each of various IP block types and a “characteristic” string which is based on the expiration date of the usage rights file and licensee identification, such as a customer name and/or number. Program 30 also generates a software key file 34 that contains a key for the “characteristic” string associated with master usage rights file 32. The program also generates keys for other software features and packages (groups of features). Other software features are associated with the software design tools themselves, such as IP block generation tools described below. A conventional software key server 36 manages the various keys in a manner well known in the art.

The system also includes IP block generation program tools or modules 40 which generate an IP block of a particular type. Before creating an IP block, generation tools 40 the generation tools checks out a key, if available, from the key server for each feature requested. The tools locate and decrypt a master usage rights file 32 that contains the characteristic string, checks out a key for the characteristic string, and, if the key is valid, generates the desired IP block and associated files, and integrates the IP block into a circuit description file (not shown). The key for the characteristic string only enables the insertion of the usage rights section in an IP block information file. The associated files include an IP block information file 42 which contains IP block access information and other information and the usage rights to be associated with the IP block. These usage rights are extracted from master usage rights file 32.

System 25 further includes a circuit database generation program or module 50 that creates a circuit database 52 which contains predetermined files associated with each of the IP blocks which were generated by generation tools 40, together with a database 54 of any embedded circuits (blocks or cores). In accordance with the present invention, program 50 also generates a circuit usage rights file 56 which combines the usage rights which were inserted into the IP block information files by IP block generation tools 40 as well as usage rights defined in a circuit usage rights file 58 which resides in database 54.

Still further, the system includes an application program or module 60 which is designed to access IP blocks embedded in a circuit using IP block access information contained in circuit database 52. U.S. patent application Serial No. 09/954,078 filed on Sep. 13, 2001, for “Method, System and Program Product for Testing and/or Diagnosing Circuits using Embedded Test Control Access Data”, incorporated herein by reference, discloses an application program contemplated herein. Program 60 operates in an environment which includes a software key server 62 and checks out a software key 64 for itself and prior to accessing any IP block in the circuit. More specifically, prior to performing a requested operation associated with an IP block, program 60 locates and decrypts a circuit usage rights file 56 associated with a circuit, parses the file to determine whether the operation is permitted and only perform the operation if it is permitted. Otherwise, the program issues an error message.

The system of the present invention includes a license manager 70 for use by the IP block vendor or authorized representative in updating or upgrading usage rights after manufacture of the circuit. A user sends the encrypted circuit usage rights file 56 to the IP block vendor with a request to upgrade the usage rights in some manner. Using the license manager, the vendor decodes the file modifies the rights, encrypts the file and sends it back to the end user.

### Master Usage Rights File

The content of the master usage rights file is illustrated in FIG. 5. The IP block vendor may provide software automation tools 40 which are designed to generate IP blocks according to parameters specified by a user—a system developer or core provider. In accordance with the present invention, the IP block vendor also provides the encrypted master usage file which identifies the licensee associated with the license rights and the specific rights granted to the licensee. The usage rights are transferable to other licensees. In a preferred embodiment of the present invention, provides two mechanisms to ensure that the file is valid and not misused, i.e., that it is not modified, transferred to another customer or that the term is not extended.

The first mechanism uses a conventional software feature licensing mechanism. The mechanism embeds a feature in the form of a characteristic string into the master usage rights file. The characteristic string includes a licensee identifier, such as the customer name and/or number, together with the date of expiration of the rights to generate IP blocks. For example, the characteristic string could be “U_ABC Company2005105c, where “U” indicates that the file is a usage rights file, “ABC Company” is the name of the licensee, and “20051105” is the expiration date, Nov. 5, 2005, of the feature.

The IP block generation tool checks out a key for the master usage rights file feature before reading and using the balance of the master usage code file.

The second mechanism used to ensure the validity of the master usage rights file is that the IP block generation tools verify that the master usage rights file is encrypted before checking out the key. If the file is not encrypted, the tool issues an error and/or suppresses the insertion of usage rights section in the IP block information file.

### Application to Embedded Test Structures

A specific application of the method and system of the present invention is to IP blocks in the form of test controller circuits. Test controllers which are designed to test a particular type of circuit sub-block, such as memories, circuit logic, phase locked loops and the like. Thus, a block or core may contain several test controllers of different types and, perhaps, several test controllers of the same type. In this embodiment, the usage rights of each test controller are defined in a circuit usage rights file 56 which is stored in a database containing other files associated with the circuit.

Application software 60 is operable to access each of various types of test controllers. The access software is further designed to check the content of the usage rights file to obtain permission to use a required feature of any test controller prior to accessing the test controller to perform a test, as described previously. Preferably, the application software is designed so that it can only use an encrypted circuit usage rights file. In other words, if a usage rights file is not encrypted, the access software will not use the file and will assume that there are no usage rights for the test controllers. The usage rights file contains a distinct wrapper for each controller. Each such wrapper specifies rights for each of predetermined features of each type of test controller for each of one or more applications of the access software, as described later. Preferably, the access software determines whether the usage rights file lists all, and only all, licensed IP blocks. The identity of the licensed IP blocks is stored in a licensed IP block file (not shown) stored in the circuit database. Thus, the access software assumes no access rights if a usage rights file stored in the circuit database contains a different set of test controllers. This is to ensure that a usage rights file is associated with a unique chip.

The application software in this embodiment contemplates four applications including simulation, IC manufacturing, board level testing and in system testing. The simulation application involves using a test controller with a simulation server of the application software. The IC manufacturing application involves accessing and using one or more test controllers during manufacturing of a circuit. The board level testing application involves using one or more test controllers to perform a board level test. The in system test application involves accessing and using one or more test controllers to perform a system test of the system in which an IC is located. It will be understood that other applications can be developed for various types of IP blocks.

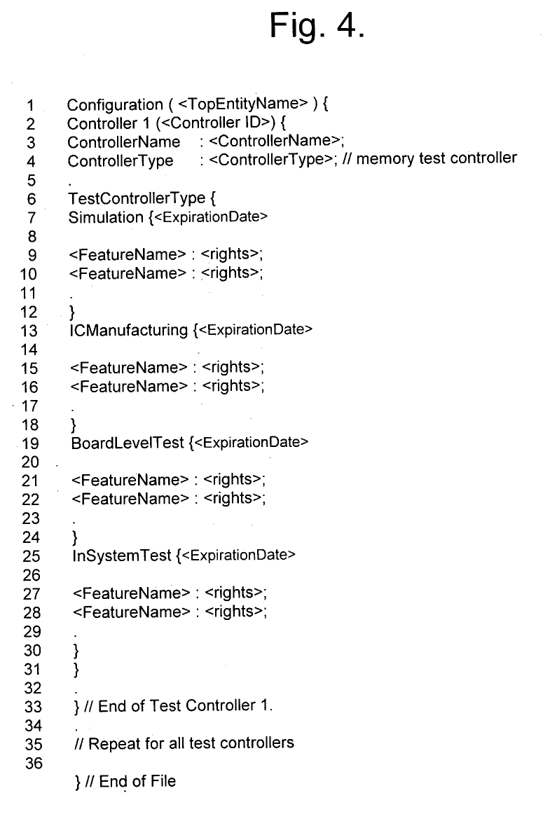

FIG. 4 illustrates the contents of the circuit usage rights file 56. The circuit usage rights file 56 contains a main wrapper which encapsulates one or more test controller wrappers. The name of the main wrapper may be the name of the top module in the circuit, Each test controller wrapper includes a controller name property, a controller type property and an application wrapper for each application which contains feature names and corresponding rights. In addition, each application wrapper has an expiration date. The same application wrapper can be repeated several times with different expiration dates.

The application software is operable to scan all unexpired application wrappers and use the highest level of rights located for a given feature. For example, a user may have acquired a usage right to perform GO/NO-GO testing for a period of 100 years. This right would be defined in a first wrapper for the affected application and contain an appropriate expiration date. The user may also have acquired the right to perform Full diagnostic testing for a period of three months. This right would be defined in a second wrapper for the same application, but contain a corresponding expiration date. Thus, the user will then have the Full rights for the first three months and then, when the Full rights expire, the rights will revert to the GO/NO-GO rights only. It will be seen, therefore, that the present invention provides a method by which different levels of usage rights for any feature of any IP block may be provided and may be scheduled to expire at any desired time.

The master usage rights file 32 is stored in a “key” directory and is intended to complement conventional electronic design automation (EDA) software licence keys. The file-is similar to circuit usage rights file 56 except that name of the main wrapper is the aforementioned characteristic string and the main wrapper encapsulates a wrapper for each test controller “type” instead of for each test controller. The contents of the test controller test wrappers is the same as those of the circuit usage rights file, i.e. application wrappers which list the features of each application and a corresponding right for each feature. However, unlike the circuit usage rights file, the application wrappers do not include an expiration date. A key for the characteristic string is managed by the key server.

The test controller generation tools are designed to decrypt the master usage rights file, read the characteristic string, and check out a key for this characteristic string. If a key is checked out successfully, the usage rights section in the IP block information file is created with appropriate usage rights indicated by the master usage rights file. This linking of the generation rights file to the standard software encryption key prevents the transfer of the contents of the generation rights file from one user to the another and provides the ability of building test controllers with a given set of usage rights which expire on a predetermined expiration date unless renewed.

The database generation tool collects the individual usage rights for all instances of all controllers and stores the information in the usage rights file. When creating a database for a collared core, the usage rights of all controllers originate from their respective test controller information files. When a database is created for a chip, the usage rights of controllers originating from a lower level database are extracted from the usage rights file associated with the lower level database. The usage rights of controllers originating from the top level workspace are extracted from the respective top level test controller information files. The fact that the usage rights are first transferred from a master usage rights file into test controller information files by the generation tools then from the test controller information files to the circuit usage rights file guarantees that usage rights of cores cannot be upgraded by a chip integrator. For example, if a chip integrator attempts to hide the usage rights file of a lower level database to make it appear as if the collared core is part of a higher level workspace, the usage rights of the lower level controllers will not be integrated into the usage rights file of the upper hierarchical level. As a result, the circuit usage rights file will not contain any test controller wrappers and rights for the controllers in the lower level core or block.

The circuit database contains information on how to run any and all usage features for all supported applications, even though the usage rights file may not currently allow such usage rights. A user might decide to acquire right to a particular function long after the database and the IC have been created. This usage will be enabled with a simple update to the usage rights file. The customer will send his usage rights file to the vendor, or an authorized representative. A utility is provided to view the content of this file and enable the desired usages. The tool allows updating one usage of one controller, all controllers of a certain types with a given usage, or all controllers of all type with precise features and so forth. The usage rights file will be modified and rewritten in its encrypted form by this utility. The modified file will then be returned to the user.

Although the present invention has been described in detail with regard to preferred embodiments and drawings of the invention, it will be apparent to those skilled in the art that various adaptions, modifications and alterations may be accomplished without departing from the spirit and scope of the present invention. Accordingly, it is to be understood that the accompanying drawings as set forth hereinabove are not intended to limit the breadth of the present invention, which should be inferred only from the following claims and their appropriately construed legal equivalents.

We claim:

1. A method of controlling access to Intellectual Property (IP) blocks embedded in a circuit, comprising:
decoding a circuit usage rights file associated with said circuit and delineating usage rights associated with said IP blocks;
determining from said circuit usage rights file whether access to an IP block to be accessed is permitted; and
accessing said IP block only if access thereto is permitted.

2. A method as defined in claim 1, further including, prior to said decoding, determining whether said circuit usage rights file is encrypted and, if not encrypted, terminating access of said IP blocks.

3. A method as defined in claim 1, further including:
creating a circuit usage rights file delineating usage rights associated with each IP block in said circuit; and
encrypting said usage rights file to prevent unauthorized access to information within said usage rights file.

4. A method as defined in claim 3, said creating a circuit usage rights file further includes:
generating said IP blocks;
for each said IP block, creating an IP block information file containing IP block access information and usage rights information according to a master usage rights file; and
combining usage rights from each said IP block information file into said circuit usage rights file.

5. A method as defined in claim 4, further including, prior to said generating said IP blocks, determining whether said master usage rights file is encrypted and, if not encrypted, either terminating said generating said IP blocks or creating an IP block information file containing IP block access information but no usage rights information.

6. A method as defined in claim 4, further including, prior to generating said IP blocks:
decoding said encrypted master usage rights file and reading a characteristic string stored therein; and
verifying that said characteristic string corresponds to a valid previously generated key and either terminating generation of said IP block or suppressing insertion of usage rights information in said IP block information file if said characteristic string does not correspond to said valid previously generated key.

7. A method as defined in claim 1, further including, prior to said creating a circuit usage rights file:
creating a master usage rights file delineating rights for using IP blocks of block types acquired by a licensee;
generating a characteristic string containing a licensee identifier and an expiration date of licensed usage rights;
embedding said characteristic string in said master usage rights file;
associating a key managed by a software key server to the characteristic string; and
encrypting said master usage rights file.

8. A method as defined in claim 7, said master usage rights file delineating:
one or more types of licensed IP blocks; and, for each IP block type specifying:
licensed features;
one or more applications with which said IP block type may be used; and
an expiration date of usage rights of said licensed features and applications.

9. A method as defined in claim 8, further including incorporating into said circuit usage rights file, usage rights from a circuit usage rights file associated with each of any blocks embedded in said circuit.

10. A method as defined in claim 9, each said IP block information file further containing a description of all features and test patterns to be used by applications supported by said IP blocks.

11. A method as defined in claim 4, further including:
creating a licensed IP block file identifying all licensed IP blocks in said circuit;
prior to accessing any of said IP blocks, verifying that said circuit usage rights file lists all and only all licensed IP blocks identified in said licensed IP block file; and
terminating access of said IP block if said circuit does not contain all and only all licensed IP blocks identified in said licensed IP block file.

12. A method as defined in claim 3, said creating a circuit usage rights file further including:
for each embedded block in said circuit having licensed IP blocks:
extracting usage rights for said licensed IP blocks from a usage rights file stored in a database associated with said embedded block; and
inserting extracted usage rights into said circuit usage rights file so as to provide a single circuit usage file defining usage rights for all licensed IP blocks in said circuit.

13. A method as defined in any one of claims 1 to 12 said creating a circuit usage rights file including inserting into said file:
an IP block identifier;
an IP block type;
a list of applications supported by the circuit;
for each application, a list of features supported by said circuit; and
an expiration date of the usage rights associated with said applications and said features.

14. A method as defined in claim 13, further including repeating an application with the same features but with different levels of rights and expiration dates.

15. A method as defined in claim 14, further including, when accessing an IP block having two or more sets of rights for the same application, selecting the occurrence having the highest level of rights.

16. A method as defined in any one of claims 1 to 12, further including:
providing software design and verification program product automation tools
for generating and verifying said IP blocks; and for transferring IP block usage rights from an encrypted master usage rights file validated by a software key server to said circuit usage rights.

17. A method as defined in any one of claims 1 to 12, further including storing said usage rights file in an IP block database associated with said circuit and containing selected information files respecting said IP blocks.

18. A method as defined in any one of claims 1 to 12, further including storing said circuit usage rights file in a handoff database associated with the circuit.

19. A method as defined in claim 18, said handoff database including said IP block information files.

20. A method as defined in claim 1, further including updating usage rights in said circuit usage rights file by:
sending said usage rights file to an authorized representative of IP block originator;
upgrading usage rights in said usage rights file; and
returning a modified encrypted circuit usage rights file to an authorized user.

21. A method as defined in any one of claims 1 to 12, wherein said circuit usage rights file is an input to application software, said application software being responsive to an input to perform operations using at least one of said IP block.

22. A method as defined in any one of claims 1 to 12, wherein said circuit usage rights file includes usage rights associated with IP blocks originating from one or more IP block vendors.

23. A method as defined in claim 22, wherein said circuit usage rights file includes usage rights associated with IP blocks licensed to different licensees.

24. A method as defined in any one of claims 1 to 12, said IP blocks being test controller circuits.

25. A system for licensing IP blocks embedded in circuits, comprising:
an IP block generator for generating an IP block, creating an IP block information file, inserting in said IP block information file, IP block access information and usage rights information associated with said IP block, and encrypting said IP block information file;
a circuit database generator for creating a database of predetermined files associated with each IP block embedded in said circuit and of any other blocks embedded in said circuit and for creating a circuit usage rights file and encrypting said circuit usage right file for said circuit; and
an application program for accessing said IP blocks, said access program being operable to decrypt a circuit usage rights file associated with said circuit, verify that rights to access said IP block have not expired, determine whether required IP block rights have been licensed for use and access said IP block if required rights have been licensed and have not expired.

26. A system as defined in claim 25, further including a program module for creating a licensee master usage rights file containing IP block usage rights.

27. A system as defined in claim 25, further including a program module for updating or upgrading a circuit usage rights file containing IP block usage rights.
